(19) United States
(12) Patent Application Publication
(10) Pub. No.: US 2021/0308993 A1
(43) Pub. Date: Oct. 7, 2021

(54) VEHICULAR INTERIOR MATERIAL AND METHOD OF MANUFACTURING THE SAME

(71) Applicants: HYUNDAI MOTOR COMPANY, Seoul (KR); KIA MOTORS CORPORATION, Seoul (KR)

(72) Inventors: Jae Hyun An, Seosan-si (KR); Myeong Su Bok, Suwon-si (KR); Byoung Wook Kim, Gunpo-si (KR); Kyu Rok Kim, Hwaseong-si (KR); Seul Yi, Seoul (KR); Ik Jin Jung, Ansan-si (KR)

(21) Appl. No.: 17/090,610

(22) Filed: Nov. 5, 2020

(30) Foreign Application Priority Data
Apr. 6, 2020 (KR) 10-2020-0041491

(51) Int. Cl. B32B 27/08; B32B 3/26; B32B 27/30; B32B 27/34; B32B 27/36; B32B 25/08; B32B 25/16; B29C 45/16

(52) U.S. Cl. CPC B32B 27/08; B32B 3/266; B32B 27/308; B32B 27/34; B32B 27/365; B29K 2033/12; B32B 25/16; B29C 45/16; B32B 2605/003; B32B 2307/558; B32B 2250/02; B32B 25/08

(57) ABSTRACT

The present disclosure provides a vehicular interior material. The vehicular interior material includes a skin layer having a thickness of 1.25-1.8 mm and a garnish layer having a thickness of 2.4-2.75 mm and positioned on the lower surface of the skin layer. The skin layer and the garnish layer are integrally formed through injection molding such that the skin layer surrounds a side wall of the garnish layer.

### CROSS REFERENCE TO RELATED APPLICATIONS

This application claims under 35 U.S.C. § 119(a) the benefit of priority to Korean Patent Application No. 10-2020-0041491 filed on Apr. 6, 2020, the entire contents of which are incorporated herein by reference.

### BACKGROUND

### (a) Technical Field

The present disclosure relates to a vehicular interior material and a method of manufacturing the same. More particularly, it relates to a vehicular interior material and a method of manufacturing the same, in which a skin layer and a garnish layer are provided through double injection so as to enable the interior material to have a high-gloss surface and to realize a low defect rate.

### (b) Background Art

Since the combination (PC/ABS-based alloy resin) of polycarbonate (PC) and acrylonitrile-butadiene-styrene (ABS) is capable of exhibiting the heat resistance and impact resistance of polycarbonate (hereinafter, referred to as PC) as well as the workability and chemical resistance of acrylonitrile-butadiene-styrene (hereinafter, referred to as ABS), the combination has excellent workability and mechanical properties.

Furthermore, since the combination of PC and ABS has improved physical properties compared to ABS, and is less expensive than PC, the combination may be used for various purposes. Particularly, since NH(Non-halogen)-PC/ABS resin is less harmful to the human body and does not cause environmental contamination, it is used in various electronic products and automotive components, such as TV housings, monitor housings, hard discs, printers, batteries for notebook computers, door handles, bumpers and instrument panels.

Because the PC/ABS alloy resin, which is used in electric and electronic products and automobile components, is continually exposed to light sources such as ultraviolet light, the PC/ABS alloy resin must have light resistance or weather resistance in order to prevent aging of the plastic made therefrom upon exposure to ultraviolet light.

In addition, such products and components must have high heat resistance so as to endure high temperatures such as those caused by hot sunlight outdoors in summer months without deformation, must have low-temperature impact strength so as to prevent deterioration in the strength thereof at extremely low temperature in winter months, must have a high flow index so as to enable injection molding to form a complicated structure through a mold, and must have high tensile strength so as to endure deforming stress applied thereto during use thereof

In recent years, consumers have increasingly shown preference for vehicular interior materials made of plastic materials that are surface-treated so as to be highly glossy. In other to realize these characteristics, it is required to perform surface coating on an injection-molded product.

Accordingly, research into applying high-gloss coating to a plastic material has been actively conducted. However, conventional high-gloss coating has a problem in that a plurality of processes are required and a defect rate is increased.

The above information disclosed in this Background section is only for enhancement of understanding of the background of the disclosure and therefore it may contain information that does not form the prior art that is already known in this country to a person of ordinary skill in the art.

### SUMMARY

The present disclosure has been made in an effort to solve the above-described problems associated with the prior art. It is an object of the present disclosure to provide a vehicular interior material including a skin layer and a garnish layer, which are integrally formed through double injection molding.

Another object of the present disclosure is to provide a vehicular interior material, which is produced from different kinds of materials through double injection molding such that contraction stress attributable to utilization of different kinds of materials is distributed so as to minimize the size of a weld line.

A further object of the present disclosure is to provide a vehicular interior material, which provides a square recess corresponding to a weld line in order to improve heat resistance.

The objects of the present disclosure are not limited to the above-mentioned objects, and other objects of the present disclosure, which are not mentioned above, will be clearly understood from the following descriptions of preferred embodiments and will be apparent from the preferred embodiments of the present disclosure. The above objects and other objects of the present disclosure are achieved by the means and combinations thereof disclosed in the claims.

In one aspect, the present disclosure provides a vehicular interior material including a skin layer, and a garnish layer positioned on a lower surface of the skin layer, wherein the skin layer and the garnish layer are integrally formed through injection molding such that the skin layer surrounds a side wall of the garnish layer and the garnish layer has a larger thickness than a thickness of the skin layer.

In one embodiment, the vehicular interior material may further include a square recess, which is formed in the garnish layer so as to correspond to a weld line occurring at the skin layer.

In another embodiment, the garnish layer may have a slit portion formed in at least a portion of a rear surface thereof.

In still another embodiment, the slit portion may have a depth of 0.1-0.2 mm.

In yet another embodiment, the skin layer may be made of polymethyl methacrylate (PMMA), polyamide (PA) or a combination thereof.

In another aspect, the present disclosure provides a method of manufacturing a vehicular interior material including injecting a constituent material of a skin layer into a mold, and injecting a constituent material of a garnish layer on a lower surface of the skin layer, wherein the skin layer is configured to surround a side wall of the garnish layer.

In one embodiment, the injecting the constituent material of the garnish layer may be conducted such that a square recess is formed in the garnish layer at a location corresponding to a weld line occurring at the skin layer.

In another embodiment, the injecting the constituent material of the garnish layer may be conducted such that a slit portion is formed in at least a portion of a rear surface of the garnish layer.

In still another embodiment, the slit portion may be formed in the garnish layer so as to have a depth of 0.1-0.2 mm.

In yet another embodiment, the skin layer may have a thickness of 1.25-1.8 mm, and the garnish layer may have a thickness of 2.4-2.75 mm.

Other aspects and preferred embodiments of the disclosure are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example vehicles powered by both gasoline and electricity.

### BRIEF DESCRIPTION OF THE FIGURES

The above and other features of the present disclosure will now be described in detail with reference to certain exemplary embodiments thereof, illustrated in the accompanying drawings which are given hereinbelow by way of illustration only, and thus are not limitative of the present disclosure, and wherein:

FIG. 1 is a cross-sectional view of a vehicular interior material according to an embodiment of the present disclosure;

FIG. 2 is an exploded perspective view of a console to which the vehicular interior material according to the embodiment of the present disclosure is applied;

FIG. 3 illustrates graphs showing the results of a falling ball impact test on the vehicular interior material according to the embodiment of the present disclosure;

FIG. 4 is a rear view of a console to which the vehicular interior material according to the embodiment of the present disclosure is applied;

FIG. 5 is an enlarged view of a square recess of the console to which the vehicular interior material according to the embodiment of the present disclosure is applied; and

FIG. 6 is a cross-sectional view of a mold with which the vehicular interior material according to the embodiment of the present disclosure is manufactured.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, the reference numbers refer to the same or equivalent parts of the present disclosure throughout the several figures of the drawing.

### DETAILED DESCRIPTION

Hereinafter reference will now be made in detail to various embodiments of the present disclosure, examples of which are illustrated in the accompanying drawings and described below. While the disclosure will be described in conjunction with exemplary embodiments, it will be understood that the present description is not intended to limit the disclosure to those exemplary embodiments. On the contrary, the disclosure is intended to cover not only the exemplary embodiments, but also various alternatives, modifications, equivalents and other embodiments that may be included within the spirit and scope of the disclosure as defined by the appended claims.

Hereinafter, embodiments of the present will be described in detail with reference to the accompanying drawings. The embodiments of the present disclosure may be modified into various forms, and the scope of the present disclosure should not be construed as being limited to the following embodiments. These embodiments are provided so that this disclosure will be thorough and complete, and will fully convey the scope of the disclosure to those skilled in the art.

The term “part”, “unit” or “module” means a unit for performing at least one function or action, and may be realized by hardware or a combination of hardware.

The present disclosure is directed to a vehicular interior material 10, which includes a skin layer 100 composed of a high-gloss material having impact resistance. Furthermore, the present disclosure is directed to a vehicular interior material 10, which includes the skin layer 100 and a garnish layer 200, which are integrally formed through double injection molding so as to reduce manufacturing costs and to have prominently low defectiveness.

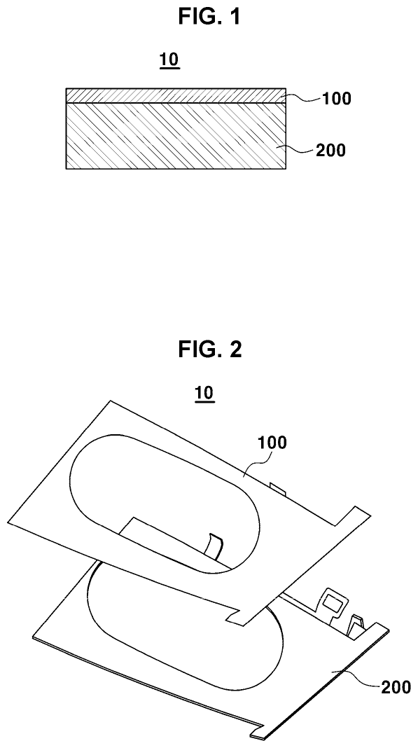

FIG. 1 is a side cross-sectional view of the vehicular interior material 10 according to an embodiment of the present disclosure, which includes the skin layer 100 and the garnish layer 200, which are sequentially formed through injection molding.

The vehicular interior material 10 according to the embodiment of the present disclosure, which includes the skin layer 100 and the garnish layer 200, may include at least some of a cluster bezel, an upper cover of a console and a crash pad, which are positioned at the front surface of a vehicle.

The skin layer 100 may be composed of a material having a high-gloss black color and scratch resistance. According to an embodiment of the present disclosure, the skin layer 100 may be composed of at least one of polymethyl methacrylate (PMMA) and polyamide (PA).

In other words, the skin layer 100 is configured to have a high-gloss black color and a high-gloss texture.

Since the skin layer 100 according to the embodiment of the present disclosure is configured to have a desired brittleness without an additional procedure of forming a coating layer and performing post-treatment (film treatment), the vehicular interior material 10 is capable of being directly applied to a vehicle after injection molding.

The garnish layer 200 may be composed of a material having a high efficiency of extension and low brittleness. The garnish layer 200 is configured to absorb impacts applied from the skin layer 100. In this regard, as the thickness of the garnish layer 200 is increased, the impact resistance thereof becomes excellent.

According to an embodiment of the present disclosure, the material of the garnish layer 200, which has impact resistance, may be composed of at least one of polycarbonate (PC) and acrylonitrile-butadiene-styrene (ABS).

The skin layer 100 and the garnish layer 200 may be formed through a double injection-molding process. Specifically, the vehicular interior material 10 may be manufactured by first molding the skin layer 100 from the material constituting the skin layer 100 and then injecting the material constituting the garnish layer 200 into a mold 300 through side gates 400.

The side gates 400 are configured such that the side gate 400 for forming the skin layer 100 is formed in the rear surface of the skin layer 100 adjacent to the side wall of the garnish layer 200 and the side gate 400 for forming the garnish layer 200 is positioned inside the side gate 400 for forming the skin layer 100.

Since the skin layer 100 is configured so as to surround at least a portion of the periphery of the garnish layer 200, the garnish layer 200 is not exposed to the interior of the vehicle. According to an embodiment of the present disclosure, in a console upper cover having a hole through which a gear knob extends, the skin layer 100 may be configured so as to surround all of the inner peripheral surface of the hole and the periphery of the garnish layer 200.

In this way, the skin layer 100 is configured so as to surround the entire side wall of the garnish layer 200, which extends upwards, thereby preventing the garnish layer 200 from being exposed to the interior of the vehicle.

FIG. 2 illustrates the individual layers of the vehicular interior material 10 according to an embodiment of the present disclosure, which is applied to a console in which a gear knob is positioned.

As illustrated in the drawing, the vehicular interior material 10 includes the skin layer 100 and the garnish layer 200, though which a gear knob extends. Preferably, the skin layer 100 may be configured to have a thickness of 1.25-1.8 mm, and the garnish layer 200 may be configured to have a thickness of 2.4-2.75 mm.

Table 1 shows the relationships between the thickness of the skin layer 100 and the thickness of the garnish layer 200, which, in a falling ball impact test, enable the garnish layer 200 to absorb the impact of the falling ball while preventing breakage of the skin layer 100.

The falling ball impact test was conducted with a ball having a diameter of 20 cm and a weight of 5 Kg in a manner such that the ball is dropped freely from a height of 1 m above the top surface of the vehicular interior material.

TABLE 1

| Items | 1 | 2 | 3 | 4 | 5 | 6 | 7 | 8 |
|---|---|---|---|---|---|---|---|---|
| Thick- | 2 | 2 | 1.5 | 1.8 | 1.8 | 1.25 | 1 | 0.8 |
| ness of | | | | | | | | |
| skin layer | | | | | | | | |
| Thick- | 2 | 2.5 | 2.5 | 2.5 | 2.4 | 2.75 | 2.5 | 2.5 |
| ness of | | | | | | | | |
| garnish | | | | | | | | |
| layer | | | | | | | | |
| Rate | 1 | 0.8 | 0.6 | 0.72 | 0.75 | 0.45 | 0.4 | 0.32 |
| Results | X | X | ◯ | ◯ | ◯ | ◯ | X | X |
| Remarks | Impact | Impact | | | | | Assem- | not |
| | break- | break- | | | | | bly | inject- |
| | age | age | | | | | Break- | able |
| | | | | | | | age | |

From Table 1, it is found that neither breakage due to impact nor breakage of assembly were caused by the falling ball in the case in which the skin layer 100 had a thickness of 1.25-1.8 mm and the garnish layer 200 had a thickness of 2.4-2.75 mm. In other words, the ratio of the thickness of the skin layer 100 to the garnish layer 200 is set to be 0.45-0.75 in double injection molding in order to realize optimized impact resistance performance.

As appreciated from the above, the thickness of the garnish layer 200 is set to be larger than the thickness of the skin layer.

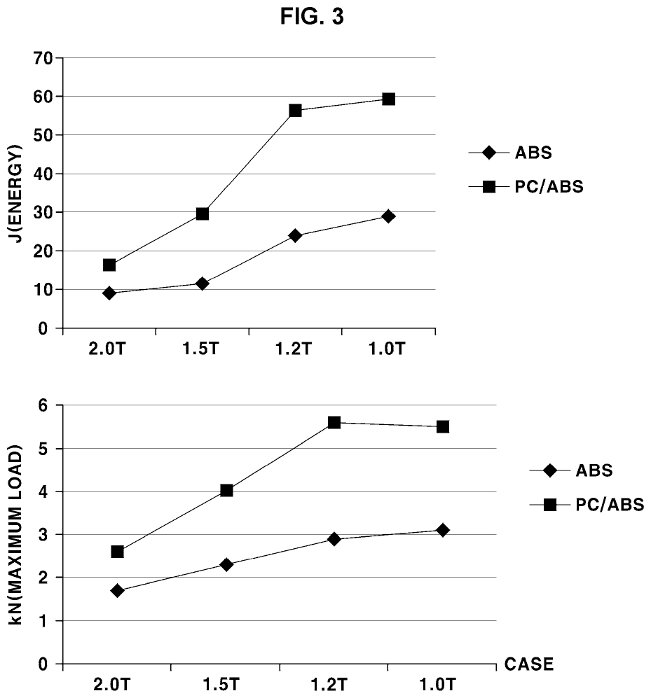

FIG. 3 illustrates data about impact absorption of the vehicle interior material 10 according to an embodiment of the present disclosure, the garnish layer 200 of which is composed of the combination of polycarbonate (PC) and acrylonitrile-butadiene-styrene (ABS), compared to data about impact absorption of a conventional vehicular interior material, the garnish layer of which is composed only of acrylonitrile-butadiene-styrene (ABS).

Accordingly, it will be appreciated that the garnish layer 200 composed of the combination of polycarbonate (PC) and acrylonitrile-butadiene-styrene (ABS) is superior to the garnish layer composed of only acrylonitrile-butadiene-styrene (ABS) in terms of absorption of impact energy and maximum support load measured when the skin layer 100 breaks.

The garnish layer 200 according to the embodiment of the present disclosure, which is composed of the combination of polycarbonate (PC) and acrylonitrile-butadiene-styrene (ABS), offers higher impact resistance performance than the conventional garnish layer, which is composed only of acrylonitrile-butadiene-styrene (ABS).

In summary, the vehicular interior material 10 shows that the efficiency of extension thereof increases as the thickness of the skin layer 100 decreases and that the impact resistance performance thereof increases as the thickness of the garnish layer 200 increases. The drawing shows that the vehicular interior material 10 has excellent impact resistance performance in the case in which the thickness of the skin layer 100 is 1.25 mm and the garnish layer 200 is composed of the combination of polycarbonate (PC) and acrylonitrile-butadiene-styrene (ABS).

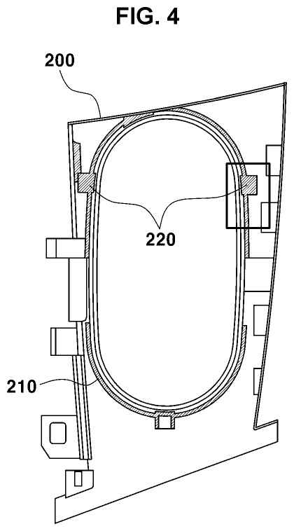

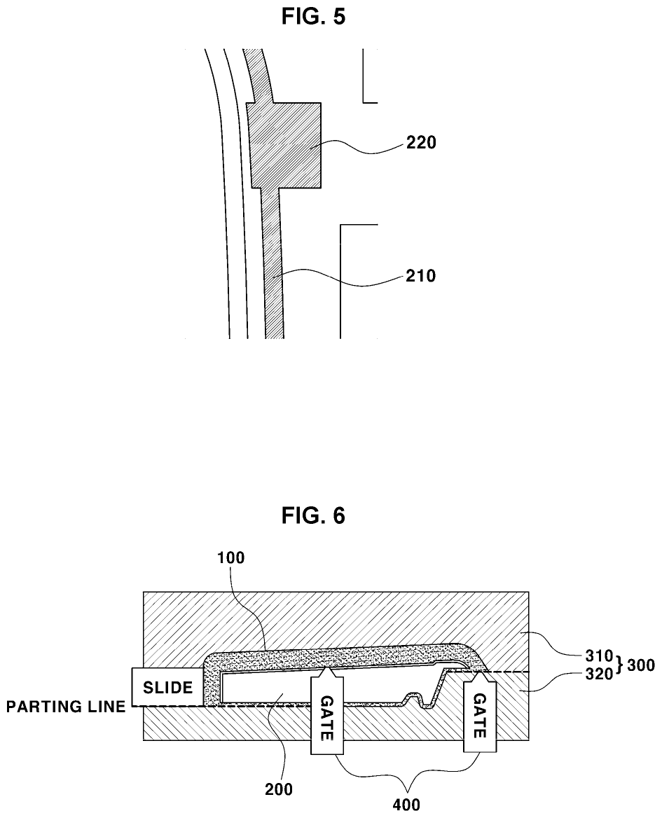

FIG. 4 illustrates the rear surface of the garnish layer 200 according to an embodiment of the present disclosure, which is completely injection-molded. FIG. 5 is an enlarged view of a square recess 220.

As illustrated in the drawings, the garnish layer 200 includes a slit portion 210 and the square recess 220.

As illustrated in the drawings, the garnish layer 200 is provided on the rear surface thereof with the slit portion 210 and the square recess 220. This is a construction for preventing the occurrence of a weld line on the skin layer 100 due to the difference in contraction rate between the skin layer 100 and the garnish layer 200.

According to an embodiment of the present disclosure, because the skin layer 100 is composed of PMMA and the garnish layer 200 is composed of the complex material of PC and ABC, residual stress and contraction stress occur between the different materials. As a result, a weld line may occur on the skin layer 100 of the vehicular interior material 10 when the internal temperature in the vehicle increases to a predetermined temperature or higher.

Hence, the garnish layer 200 is configured to include the slit portion 210, which is a volume-reducing structure, on the rear surface thereof. The depth and area of the slit portion 210 may be set such that the overall contraction rate of the garnish layer 200 decreases so as to be similar to the contraction rate of the skin layer 100. According to an embodiment of the present disclosure, the slit portion 210 may have a depth of 0.1-0.2 mm. The position of the slit portion 210 may be changed depending on the shape of the vehicular interior material 10.

Furthermore, the garnish layer 200 is provided at a region adjacent to a weld line occurring on the skin layer 100 with the square recess 220. The square recess 220 is capable of preventing a weld line on the skin layer 100, which occurs due to the difference in contraction rate between the skin layer 100 and the garnish layer 200 in the vertical direction in the drawing.

Preferably, the slit portion 210 and the square recess 220 may be integrally formed with each other, and may be formed in the rear surface of the garnish layer 200 depending on the shape of a lower mold 320 of the mold 300.

FIG. 6 illustrates a double injection-molding process of the vehicular interior material 10 according to an embodiment of the present disclosure.

The mold, which is intended to mold the vehicular interior material 10 through double injection molding, includes an upper mold 310 and the lower mold 320. First, the constituent material of the skin layer 100 is injected into the upper mold 310. The skin layer 100 is formed in such a way as to inject the constituent material of the skin layer 100 through the center gate 400 or the side gate 400. According to an embodiment of the present disclosure, the skin layer 100 may be made of PMMA. The skin layer 100 may have a thickness of 1.25-1.8 mm, and may be positioned so as to surround the entire inner side surface of the upper mold 310.

After the constituent material of the skin layer 100 is injected, the constituent material of the garnish layer 200 is injected into the space between the skin layer 100 and the lower mold 320 through the center gate 400 or the side gate 400. According to an embodiment of the present disclosure, the garnish layer 200 is made of the combination of polycarbonate (PC) and acrylonitrile-butadiene-styrene (ABS). Preferably, the garnish layer 200 has a thickness of 2.4-2.75 mm. The skin layer 100 is configured so as to surround the side wall of the garnish layer 100 to thus prevent the garnish layer 200 from being exposed through the outermost surface of the skin layer 100.

The lower mold 320 is provided with a protrusion pattern along at least a portion of the peripheral region of the garnish layer 200 or the inner surface of the hole formed in the garnish layer 200. Accordingly, the slit portion 210 may be formed in the garnish layer 200 by virtue of the lower mold 320. Preferably, the slit portion 210 may have a depth of 0.1-02 mm.

The garnish layer 200 may be provided with at least one square recess 220 at a location corresponding to a weld line occurring at the skin layer 100. Accordingly, the square recess 220 may be formed in the garnish layer 200 by providing the lower mold 320 with a projection. Preferably, the slit portion 210 and the square recess 220 are configured so as to have the same depth.

The depths and positions of the slit portion 210 and the square recess 220 may be set in consideration of the position of a weld line occurring at the skin layer 100 and the difference in contraction rate between the skin layer 100 and the garnish layer 200.

The present disclosure offers the following effects by virtue of the above-described constructions of the embodiments.

The present disclosure provides a vehicular interior material having improved heat resistance.

Furthermore, the present disclosure provides a vehicular interior material, which is manufactured at low cost.

In addition, the present disclosure provides a vehicular interior material that satisfies impact resistance.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

1. A vehicular interior material comprising:
a skin layer; and
a garnish layer positioned on a lower surface of the skin layer;
wherein the skin layer and the garnish layer are integrally formed through injection molding such that the skin layer surrounds a side wall of the garnish layer and the garnish layer has a larger thickness than a thickness of the skin layer.

2. The vehicular interior material of claim 1, further comprising a square recess formed in the garnish layer so as to correspond to a weld line occurring at the skin layer.

3. The vehicular interior material of claim 1, wherein the garnish layer has a slit portion formed in at least a portion of a rear surface thereof.

4. The vehicular interior material of claim 3, wherein the slit portion has a depth of 0.1-0.2 mm.

5. The vehicular interior material of claim 1, wherein the skin layer is made of polymethyl methacrylate (PMMA), polyamide (PA), or a combination thereof.

6. The vehicular interior material of claim 1, wherein the skin layer has a thickness of 1.25-1.8 mm and the garnish layer has a thickness of 2.4-2.75 mm.

7. The vehicular interior material of claim 1, wherein the skin layer is injected through a gate positioned at a rear surface of the skin layer, such that the skin layer surrounds a side wall of the garnish layer.

8. A method of manufacturing a vehicular interior material comprising:
injecting a constituent material of a skin layer into a mold; and
injecting a constituent material of a garnish layer on a lower surface of the skin layer;
wherein the skin layer is configured to surround a side wall of the garnish layer.

9. The method of claim 8, wherein the injecting the constituent material of the garnish layer comprises forming a square recess in the garnish layer at a location corresponding to a weld line occurring at the skin layer.

10. The method of claim 8, wherein the injecting the constituent material of the garnish layer comprises forming a slit portion in at least a portion of a rear surface of the garnish layer.

11. The method of claim 10, wherein the slit portion has a depth of 0.1-0.2 mm.

12. The method of claim 8, wherein the skin layer has a thickness of 1.25-1.8 mm, and the garnish layer has a thickness of 2.4-2.75 mm.

13. The method of claim 8, wherein the injecting the constituent material of the skin layer comprises injecting the constituent material of the skin layer through a gate positioned at a region of the skin layer adjacent to the side wall of the garnish layer.
